(19) United States
(12) Patent Application Publication
(10) Pub. No.: US 2010/0070863 A1
(43) Pub. Date: Mar. 18, 2010

(54) METHOD FOR READING A SCREEN

(75) Inventors: Fang Lu, Billerica, MA (US); Janani Janakiraman, Austin, TX (US); Susan M. Cox, Rochester, MN (US); Loulwa F. Salem, Austin, TX (US)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/211,450

(22) Filed: Sep. 16, 2008

(51) Int. Cl. G06F 3/048

(52) U.S. Cl. 715/727

(57) ABSTRACT

The present disclosure is directed to a method for reading a computer screen having a set of information and a button for submitting the set of information. The method may comprise collecting the set of information; determining a set of representative information, wherein the set of representative information is a subset of the set of information; concatenating the set of representative information to form a summarized context; associating the summarized context with the button; and producing audible sound reciting the summarized context when the button receives focus from a computer mouse.

### TECHNICAL FIELD

The present disclosure generally relates to the field of computer science, and more particularly to a method for reading a screen.

### BACKGROUND

Visually impaired computer operators/users may rely on screen readers to operate computer software. Screen readers may be configured to sequentially read out the text on a screen. A user may, for example, try to obtain an idea of the overall content of the screen, or to verify the information the user inputted/provided to the screen. In such situations, multiple sequential read outs by the screen reader may be necessary.

### SUMMARY

The present disclosure is directed to a method for reading a computer screen having a set of information and a button for submitting the set of information. The method may comprise collecting the set of information; determining a set of representative information, wherein the set of representative information is a subset of the set of information; concatenating the set of representative information to form a summarized context; associating the summarized context with the button; and producing audible sound reciting the summarized context when the button receives focus from a computer mouse.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is an exemplary diagram depicting a screen; and

FIG. 2 is a flow diagram illustrating a method for reading a screen.

### DETAILED DESCRIPTION

Reference will now be made in detail to the subject matter disclosed, which is illustrated in the accompanying drawings.

Screen readers configured to sequentially read the text on a screen may have some shortcomings. For example, when filling out a form on the screen, a user may choose to verify and/or remember information the user filled out in certain or all fields of the form before submitting the form by clicking on a submit button. If the screen reader utilized reads the screen sequentially, the user may need to force the reader to re-read the screen in order to verify.

The present disclosure is directed to a method for enabling the screen reader to recite the information to be submitted when the submit button receives focus from the computer mouse. In an exemplary embodiment, instead of hearing the screen reader describing such a button as “push button to submit”, the user may hear a more complete description summarizing the context of the information about to be submitted.

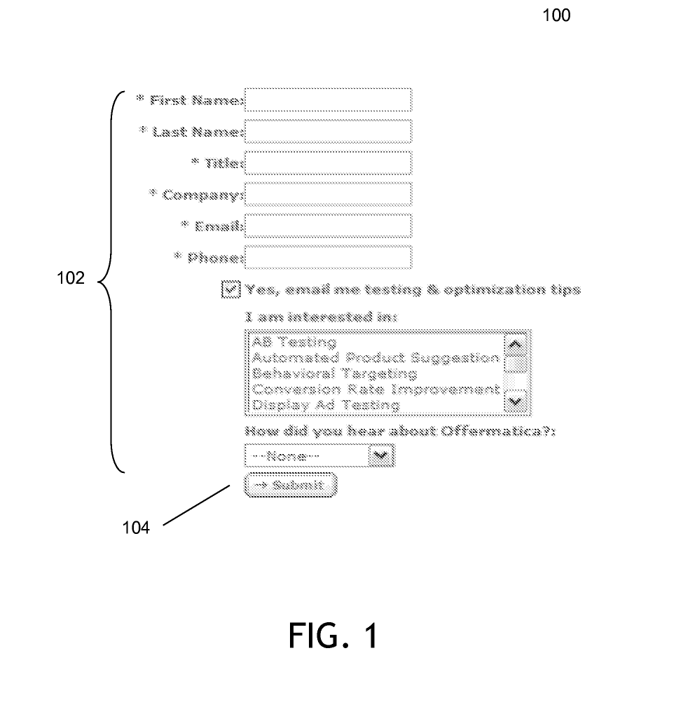

FIG. 1 depicts an exemplary screen 100 comprising a set of information 102 to be filled out and a button 104. When the button receives focus from the mouse, the screen reader may recite a summarized context of the set of information 102. An exemplary summarized context may recite “by pushing this submit button, your first name, last name, title, company, email and phone will be transmitted, would you like to proceed?”

It is understood that the set of information 102 may comprise different fields than it is illustrated in FIG. 1. It is also understood that the summarized context may comprise different combination of contents on the screen. In one embodiment, the summarized context comprises the form title and the required fields (e.g., fields denoted with stars in FIG. 1). In another embodiment, the summarized context comprises the form title and all fields. It is contemplated that additional combinations/techniques for forming the summarized context may be utilized.

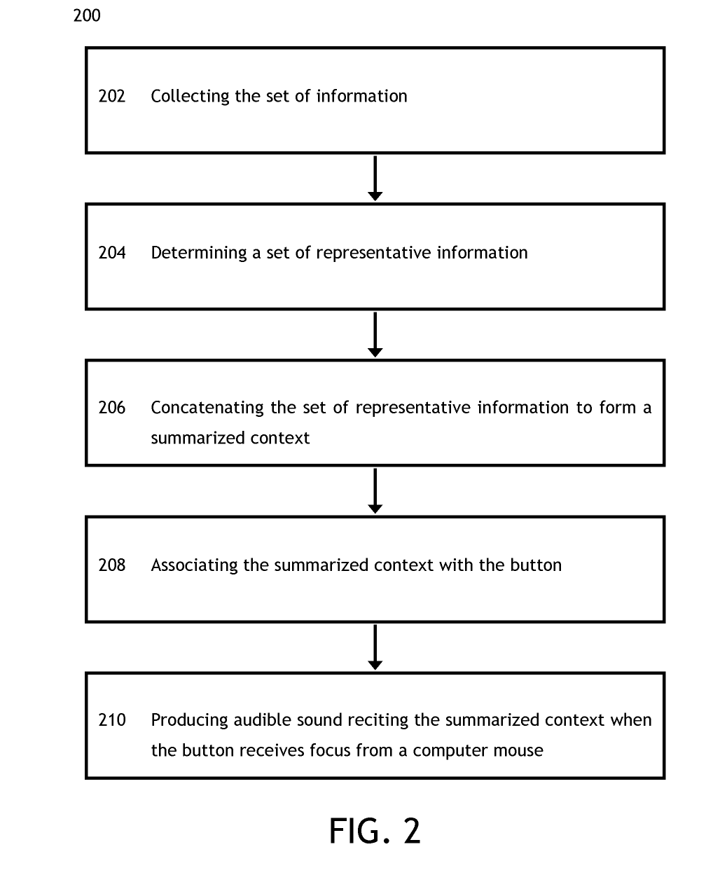

FIG. 2 shows a flow diagram illustrating the steps performed by a method 200 in accordance with the present disclosure. The method 200 may concatenate information on the screen into a summarized context, and associate the summarized context with a button. Step 202 collects the set of information on the screen. A subset of the set of information may be determined to be a set of representative information in step 204. For example, in one embodiment, the title identifying the set of information and the required input fields of the set of information may be determined to be the set of representative information. In another embodiment, the title identifying the set of information and all input fields of the set of information may be determined to be the set of representative information. In still another embodiment, the set of representative information may be equivalent to the set of information collected in step 202.

Step 206 concatenates the set of representative information to form a summarized context of the set of representative information. For example, if the set of representative information includes input fields for first name, last name, title, company, email and phone, the summarized context may be a concatenated string indicating “first name, last name, title, company, email and phone”. The summarized context is associated with the button in step 208, and when the button receives focus from a computer mouse, step 210 produces audible sound reciting the summarized context. It is contemplated that the summarized context may comprise additional information such as the action about to be performed if the button is clicked, and/or a confirmation message.

It is contemplated that the method 200 may be utilized to read specific portions of a screen. For example, the method may read a form and/or a menu item defined in a web page. A FORM HTML element may be parsed to obtain the set of information provided in the form. Similarly, an OPTGROUPS element may be parsed to obtain information representing menu lists defined in OPTION elements. It is understood that both types of elements may be utilized by the reader to present the summarized context to the user before the information is actually submitted.

It is understood that when reading pages where form and/or menu elements are not present, other elements such as titles and/or labels of fields may be utilized to provide contextual content to the user. Alternatively, the reader may store/record information from different elements on the screen to generate the summarized context.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A computer program product for reading a computer screen having a set of information and a button for submitting the set of information, comprising:
a tangible computer usable medium having computer usable code tangibly embodied therewith, the computer usable code comprising:
computer usable program code configured to collect the set of information, wherein collecting the set of information includes parsing a FORM HTML element and a OPTGROUP element, the FORM HTML element associated with a set of information provided in a form, the OPTGROUP element associated with at least one menu list item defined in at least one OPTION element;
computer usable program code configured to determine a set of representative information, wherein the set of representative information is a subset of the set of information;
computer usable program code configured to concatenate the set of representative information to form a summarized context;
computer usable program code configured to associate the summarized context with the button; and
computer usable program code configured to produce audible sound reciting the summarized context when the button receives focus from a computer mouse.
